(19) United States
(12) Patent Application Publication
(10) Pub. No.: US 2006/0136231 A1
(43) Pub. Date: Jun. 22, 2006

(54) System and method for conducting residential financing transactions

(76) Inventor: Adbulkader Thomas, Kuwait City (KW)

Correspondence Address: RICHARD I. SAMUEL;GOODWIN PROCTER L.L.P, 599 LEXINGTON AVE., NEW YORK, NY, 10022, US

(21) Appl. No.: 10/534,896

(22) PCT Filed: Oct. 28, 2003
(86) PCT No.: PCT/US03/34339

§ 371 Date: Oct. 26, 2005

Related U.S. Application Data
(63) Continuation-in-part of application No. 60/421,689, filed on Oct. 28, 2002.

(51) Int. Cl. G06Q 99/00; G06Q 40/00

(52) U.S. Cl. 705/1; 705/35

(57) ABSTRACT

As provided by the exemplary method described herein, a single-asset trust would be established by the originator, as settlor, naming a special purpose entity as the trustee. The trust would be subject to the terms of a written indenture designed for this specific purpose which would be used generically by all originators participating in the program. The funds necessary to acquire the real property would be deposited into the trust by the originator, as settlor, and used to fund the purchase of the property. The trust would then enter into a combination lease/contract-for-deed agreement with the lessee/purchaser. The settlor would be the initial beneficiary of the trust, but the beneficial interest in the payment stream arising from the trust would be assignable to third parties. The power to remove and appoint trustees would be granted to the beneficiary and the beneficiary would have the power to direct the trustee with respect to foreclosure of the property. These rights would be assignable with the payment stream.

### PRIORITY CLAIM

This application claims the benefit of priority of U.S. application No. 60/421,689, filed Oct. 28, 2002, the entire contents of which are incorporated by reference as if set forth at length herein.

### FIELD OF THE INVENTION

This invention generally relates to the field of financial services.

### BRIEF DESCRIPTION OF THE DRAWINGS

The Figures depict various aspects and features of the present invention in accordance with the teachings herein.

### DESCRIPTION OF THE INVENTION

The following discussion and accompanying drawings describes the principal aspects, features and advantages of the present invention. What follows are exemplary embodiments of the present invention and, in particular exemplary embodiments in accordance to the commercial laws of the US. It should be apparent to those skilled in the art that the foregoing is illustrative only and not limiting, having been presented by way of example only (e.g., the invention may be adapted to the commercial laws of various jurisdiction). All the features disclosed in this description may be replaced by alternative features serving the same purpose, and equivalents or similar purpose, unless expressly stated otherwise.. However, numerous other embodiments of the modifications thereof are contemplated as falling within the scope of the present invention as defined herein and equivalents thereto.

### Introduction

There are several million U.S. consumers whose religious convictions prevent the payment and receipt of interest. The invention described herein allows these consumers to engage in a standardized program for the financing of a home purchase, both as purchasers and investors. The nature of this program is the structuring of a lease (“Lease”) and a contract for deed, resulting in a transaction that has the same legal effect as a conventional residential mortgage transaction. In this process (the “SHAPE Process”), the consumer leases to own while saving to buy out the Lease. The method has been approved by leading Islamic scholars who are experienced in financial contracts and western markets.

The following issues are described in greater detail below:
The Transaction Model
Warehousing and Assignment
Servicing
Post-Closing and Secondary Market Transactions

### The Transaction Model

Overview

As contemplated, a single-asset trust would be established by the originator, as settlor, naming a special purpose entity as the trustee. The trust would be subject to the terms of a written indenture designed for this specific purpose which would be used generically by all originators participating in the program. The funds necessary to acquire the real property would be deposited into the trust by the originator, as settlor, and used to fund the purchase of the property. The trust would then enter into a combination lease/contract-for-deed agreement with the lessee/purchaser. The settlor would be the initial beneficiary of the trust, but the beneficial interest in the payment stream arising from the trust would be assignable to third parties. The power to remove and appoint trustees would be granted to the beneficiary and the beneficiary would have the power to direct the trustee with respect to foreclosure of the property. These rights would be assignable with the payment stream.

Documentation

The SHAPE Process requires the following documents:

Lease: This is an agreement for the purchaser/lessee to use property which the purchaser/lessee intends to purchase and for which the purchaser/lessee will make installment payments. This document is cross-defaulted with the Promise to Purchase (described below) by reference. Lease payments under this document are tantamount to interest, insurance and taxes.

Promise to Purchase: This document is the contract-for-deed vehicle under which the purchaser/lessee makes installment payments which are equivalent to standard mortgage amortization payments. The document incorporates the preferred standard Freddie Mac/Fannie Mae enforcement procedures, although other procedures may be used, and is cross defaulted with the Lease.

Lessor's Promise to Sell: The Lessor makes a one page promise to the purchaser/lessee to sell the property only to the purchaser/lessee at the price indicated in the Promise to Purchase unless the purchaser/lessee has triggered default provisions.

Memorandum of Lease and Promise to Purchase: This is the recorded document which binds the Lease and Promise to Purchase as a mortgage loan like document.

Trust Indenture. This is the document governing the trust, establishing the beneficiary's rights with respect to the revenue stream, foreclosure and designation of the trustee (see discussion below under Closing and creation of trust interest).

Trust Participation Certificate or Registry Entry (TPC): This is the functional equivalent of the transfer of a negotiable instrument or investment security to evidence the investor's interest in the lease/purchase arrangement, and provides for the assignment of incidental aspects of ownership to the holder from the Lessor mandated under Islamic law. The incidents of ownership are the ability to replace the trustee and to direct the trustee's activity with respect to foreclosure and: the right of inspection of the Property, upon proper and reasonable notice to Purchaser/lessee; the ability, but not the obligation, to cure any defect regarding the Property, subject to the giving of reasonable notice to Purchaser/Lessee and Beneficiary; and the right to approve, but not pay for, of any significant improvements to the Property.

Origination

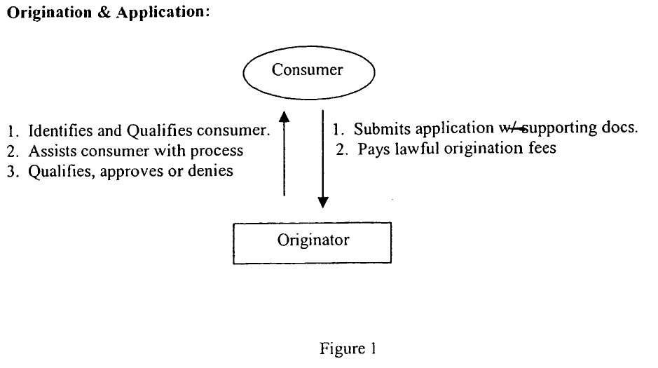

Referring to FIG. 1, upon securing an interested consumer's indication of interest in the program, the originator will receive from the consumer an industry standard mortgage loan application, process and underwrite the application in accordance with investor guidelines, and deliver to the consumer all disclosures and notices required by law in connection with a residential mortgage loan transaction. Pre-approved consumers will obtain a pre-approval letter leading to a commitment letter and ultimately the closing date. The rental to be paid under the Lease would be treated as a finance charge for purposes of calculation and disclosure of the annual percentage rate and related disclosures under the Truth-in-Lending Act. It is expected that consumers will pay standard market fees for third party costs related to origination, including costs for credit reports, appraisals, title services, and transaction settlement.

The intent of the program is to finance homes as primary residences of the consumers applying thereto. Consumers will agree in the Lease to occupy the property as their primary residence for at least one year and to take up occupancy not more than 60 days after closing, although other time periods may be used.

FIG. 1 depicts an exemplary embodiment of the present invention regarding the origination and application process.

Closing and Creation of Trust Interest

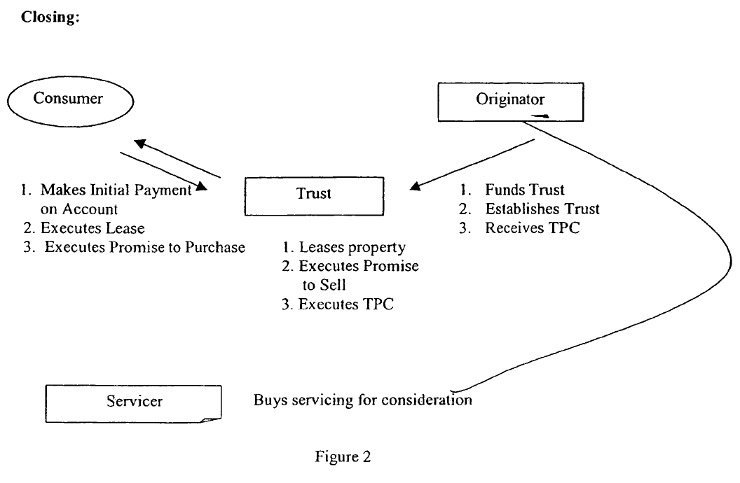

Referring to FIG. 2, the originator will close and fund according to applicable law. The originator will establish an irrevocable trust under a uniform Trust Indenture, and then fund the same. The trust will hold title with licensee as initial beneficiary. The trust will execute the Lease with the purchaser/lessee as well as the Promise to Purchase.

As noted above, the rights of the beneficiary are assignable. It should be possible to treat the TPC as an investment security for purposes of managing assignment of interests. Under UCC Revised Article 8, a security includes a participation, or other interest in an issuer or in property or an enterpris of an issuer which is: represented by a security certificate in bearer or registered form, or the transfer of which may be registered upon books maintained for that purpose by or on behalf of the issuer; one of a class or series or by its terms is divisible into a class or series of participations or interests; and a medium for investment and by its terms expressly provides that it is a security governed by Revised Article 8. The Trust Indenture would expressly state that the TPCs will be treated as an investment security under Revised Article 8 of the Uniform Commercial Code. A 100% trust participation could either be evidenced by a written trust certificate, or transferred electronically on the books of a registry maintained by or on behalf of the trustee. The beneficiary's interest could then be transferred, either by negotiation of the original certificate (if certificated) or transfer of the interest on the records of the trustee (if recorded by registry entry), free and clear of intermediate interests. Under UCC Revised Article 9, now effective in all 50 states plus the District of Columbia, and under UCC Revised Article 8, an ownership or security interest in a certificated security issued in a registered name may be perfected by taking possession of the certificate with appropriate indorsements; an interest taken in this manner takes priority over all other claims to the security. Similarly, an ownership or security interest in an uncertificated security taken by registration on the records of the issuer takes priority over competing interests not reflected in the registration. UCC Rev. §8-106; UCC Rev. §§9-106, 9-312, 9-313(a), 9-314 and 9-328.

The beneficiary's interest would be composed of (i) the right to the revenue stream for all rental earned, and all amounts due on account and unpaid, on or after the date the beneficial interest is transferred, and (ii) the right to direct the trustee with respect to foreclosure and sale of the property after default. This tying of the revenue interest to the right to direct foreclosure is important for purposes of the Islamic principles involved. A revenue interest disassociated from any other rights would not be acceptable under Islamic law either for the purchaser/lessee or for a Muslim investor.

FIG. 2 depicts an exemplary embodiment of the closing process.

Insurance, Liability and Bankruptcy

In another embodiment of the SHAPE Process, the originator arranged a master home owner policy. Purchaser/lessees also had the absolute option to obtain a standard HO3 policy through their own agent with a company of their choosing. In the one example of Originator closings, the master home owner policy was not available and the purchaser/lessees arranged HO3 cover through their existing agents or alternative asset replacement protection, such as debt cancellation insurance. Provided that the contract-for-deed structure is maintained, the purchaser/lessee should be eligible for coverage under a standard HO-3 broad form homeowners comprehensive risk insurance policy.

As a general matter, the trustee is potentially liable in negligence for injuries occurring on the real property owned by the trust. The trustee and the trust could be listed as an additional insured under the purchaser/lessee's homeowner's policy, which would afford the trustee protection both from property and casualty losses, and afford a first layer of coverage for liability claims, as well. Additional coverage against claims could be provided via a blanket liability excess coverage policy. Because each property would be held in a separate trust, and the trustee is neither the settlor or the beneficiary, the real property held in the trust, and in other similar trusts administered by the trustee, would not be available to satisfy claims against the trustee.

Classification of the Combination Lease and Promise to Purchase as a Mortgage

Generally, the classification of real property interests is a matter of state law. The courts have been liberal in their classification of an interest as a mortgage, both for purposes of identifying an estate in realty and for purposes of establishing the right to pursue the appropriate state law remedies. A contract for deed, in which the purchaser occupies the property and agrees to purchase the property by making installment payments over time in return for delivery of a deed when all the installments have been paid, is recognized as a mortgage. Restatement of Property/Mortgages 3d, § 3.4. See, for example, FL ST §697.01; Cain & Bultman, Inc. v. Miss Sam, Inc., 409 So. 2d 114 (Fla. 1982); In re Kampman Farms, Inc., 6 B.R. 653 (1980) (interpreting Oklahoma Law).

In some states, the contract for deed is separately addressed by statute, sometimes being referred to as a “land installment contract.” See, for example, Md Code Real Property Ann §10-101 et seq.

The purchaser is regarded as having an equitable interest in the fee simple title to the property, even though legal record title is vested in the seller. See, for example, Torcise v. Perez, 319 So. 2d 41 (Fla. App. 1975).

In the same vein, courts have recognized the use of a lease, coupled with a right to purchase the property, as a mortgage equivalent. See, for example, Cinque v. Buschlen, 442 So. 2d 1034 (Fla. App. 1983). Courts have often maintained that it is the intention of the parties which establishes the characterization of the real property interest for purposes of recording and establishing rights and remedies. See, for example, Valk v. J.E.M. Distributors of Tampa Bay, 700 So. 2d 416 (App. 1997). The lease and contract for deed documents approved by the Shari'ah Council for compliance with Islamic law include specific statements that it is the parties' intention to create a mortgage interest in the property.

For purposes of remedies, lease arrangements have, under appropriate circumstances, been enforced as mortgages.

### Warehousing/Assignment

The originator may choose to deal with a warehouser. The warehouser would operate in a manner similar to a traditional warehouse lender, except that it would fund (perhaps even table fund) against taking an assignment of the TPC. Islamic law allows the transfer of a minimal set of ownership rights, not significantly distinct from what a lender would seek in a security instrument, for negotiated consideration. Therefore, the warehouser and originator may negotiate a price for the TPC. From an Islamic law perspective, the purchased interest is the beneficial interest in the revenue stream from the trust's ownership/lease/sale of the property subject to lease. The trust beneficiary receives:
Assignment of an Article 8 security, namely the TPC, which carries with it:
Specific incidental elements of ownership embedded in the Lease and Promise to Purchase (see attached documents) and the Trust Indenture, subject to Lessor's Promise to Sell; and
The right to the revenue stream arising from the Lease and sale of the real property in the trust.

### Servicing

It is expected that transactions originated using the SHAPE Process will be serviced in accordance with industry standards for, and applicable federal and state laws governing, residential mortgage loan transactions, including any investor requirements. Servicing may be retained by the originator, it may be assigned to an investor along with the TPC or it may be sub-contracted to a third-party provider.

### Post Closing & Secondary Marketing

In Post Closing, whether or not there has been a secondary market sale of the TPC, the servicer (or sub-servicer) will continue service through one of the following four events:

Breach: In the event the Lessee breaches the Lease, Promise to Purchase, and TPC, the documents provide for a notice of default and a cure period, for the preferred embodiment, of at least 30 days. If the breach is not cured within the cure period, the documents provide that the Lessor may accelerate the Promise to Purchase by notifying the Lessee that the Lessor will cause the property to be sold if the Lessee does not close the purchase of the property within, for the preferred embodiment, 30 days. If the Lessee does not close the purchase during that time, the documents provide that the Lessor can proceed to sell the property.

Foreclosure: Upon the purchaser/lessee's failure to pay as promised under the TPC and inability or refusal to re-instate and cure a default, as described above, the Lease termination is achieved through a cross default with the Promise to Purchase, allowing the trustee to seek enforcement under the traditional remedies of a standard Freddie Mac/Fannie Security Instrument, which are incorporated in the Promise to Purchase, and the purchaser/lessee will be foreclosed out of any and all rights in property, and the property sold. The expected sale of the property is to be pursuant to non-judicial foreclosure. If there is an excess above foreclosure costs and the financier's basis in the property, it will be returned to the purchaser/lessee. As in a traditional foreclosure, there is no assurance that the costs of the process will remit more than the Lessor's basis and costs of foreclosure.

Pre-term lease buy-out: Should the purchaser/lessee no longer wish to lease and acquire the property, the purchaser/lessee will give notice of the purchaser/lessee's desire to sell the property. The servicer on behalf of the financier will appoint the purchaser/lessee agent to sell the property. The purchaser/lessee will then market the property and at the closing the technical order of settlement is purchaser/lessee to financier, market buyer to purchaser/lessee.

Term of Lease dollar buy-out: In this case, the purchaser/lessee fulfills all of his or her obligations over the full term of the Lease. The purchaser/lessee will then be able to buy out the Lease at its term for the payment of one dollar.

### Summary

The SHAPE Process is structured to simulate the standard mortgage loan-based home acquisition financing process. The documents utilized in the SHAPE Process provide for the financing of the acquisition of a residence by a consumer in a manner that does not involve the payment of interest, in conformity with the consumer's religious beliefs. Transactions originated using the SHAPE Process are intended to be serviced and enforced in the same manner and subject to the same laws as residential mortgage loans. The SHAPE Process also results in the creation of an asset that provides investors rights that are equivalent to those held by investors of traditional mortgage loan promissory notes. In addition, the SHAPE Process is structured so that an investor whose religious beliefs prohibit investment in interest-bearing assets may acquire assets created using the SHAPE Process in conformity with such beliefs. As a result, the present invention is designed to provide a methodology for consumers to purchase a residence and investors to acquire an asset secured by a residence in conformity with religious beliefs against payment or receipt of interest in a manner that most closely mirrors the bundle of legal rights and obligations afforded the parties under the traditional residential mortgage loan structure.

### CONCLUSION

Having now described a preferred embodiment of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

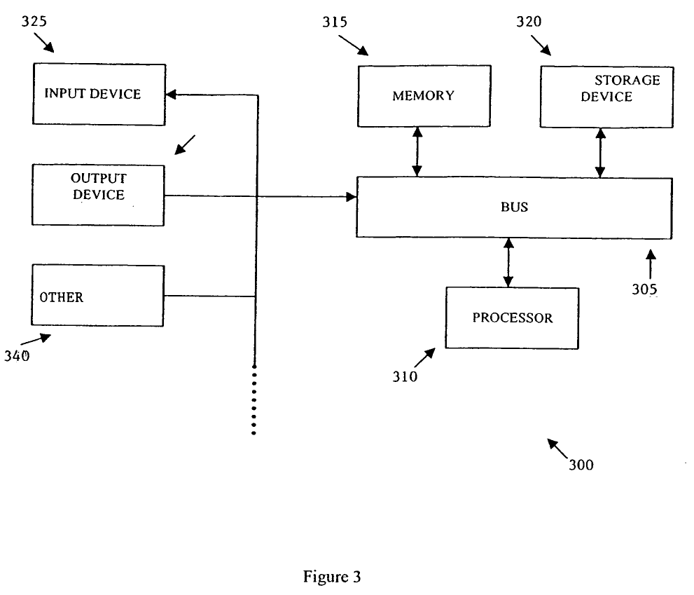

For example, the present invention may be implemented in hardware or software, or a combination of the two. See FIG. 3. Preferably, the present invention is implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

What is claimed is:

1. An asset acquisition financing method, comprising:
establishing a trust vehicle by an originator/settlor as a beneficiary to said trust vehicle;
establishing a special purpose entity as trustee of said trust vehicle;
funding said trust vehicle by said originator/settlor, said funds for use in purchasing an asset to be associated with said trust vehicle; and
entering into a combination lease/contract-for-deed asset agreement between said trustee and a lessee/purchaser; wherein said trust vehicle includes an assignable beneficiary rights including: the power to remove and appoint trustees, the power to direct the trustee with respect to foreclosure of the property, and the power to collect a payment stream arising from said trust vehicle.

2. The method of claim 1, wherein said asset is real property.
